(19) United States
(12) Patent Application Publication
(10) Pub. No.: US 2007/0085598 A1
(43) Pub. Date: Apr. 19, 2007

(54) Integrated semiconductor circuit comprising a voltage pump and method for operating an integrated semiconductor circuit comprising a voltage pump

(76) Inventors: Musa Saglam, Muenchen (DE); Kai Schiller, Muenchen (DE)

Correspondence Address: SLATER & MATSIL LLP, 17950 PRESTON ROAD, SUITE 1000, DALLAS, TX, 75252, US

(21) Appl. No.: 11/544,307

(22) Filed: Oct. 6, 2006

(30) Foreign Application Priority Data
Oct. 7, 2005 (DE) 10 2005 048 195.7

(51) Int. Cl. G05F 1/10

(52) U.S. Cl. 327/536

(57) ABSTRACT

A semiconductor circuit includes a voltage pump, which has a series circuit of capacitors. The voltage pump furthermore has first switching elements, which are coupled between, in each case, two capacitors of the series circuit, and are coupled to capacitor electrodes of the capacitors by coupling lines. Connection lines are coupled to a respective connecting line and, in each case, have a second switching element, which enables an interruption of the respective connection line. It is possible for the second switching elements to be jointly switched to a conducting state when all the first switching elements are switched to a non-conducting state, as a result of which each capacitor is electrically charged individually by in each case two connection lines. It is also possible for the first switching elements to be jointly switched to a conducting state when all the second switching elements are switched to a non-conducting state, as a result of which all the electrically charged capacitors are electrically connected to one another.

This application claims priority to German Patent Application 10 2005 048 195.7, which was filed Oct. 7, 2005 and is incorporated herein by reference.

### TECHNICAL FIELD

The invention relates to an integrated semiconductor circuit comprising a voltage pump, and to a method for operating an integrated semiconductor circuit comprising a voltage pump.

### BACKGROUND

Integrated semiconductor circuits are operated with predetermined operating voltages for which they are designed. Since voltages that are greater than the operating voltage provided are required in partial regions of an integrated semiconductor circuit, semiconductor circuits conventionally contain so-called voltage pumps, which generate an even higher voltage from the predetermined operating voltage. Such voltage pumps are in some instances also referred to as charge pumps. Voltage pumps usually contain a plurality of capacitors, generally two or at most three capacitors, which are charged periodically over time, a first capacitor (called the first stage of the voltage pump) being used to transfer in each case a portion of the charge on one of its two electrodes to an electrode of the downstream capacitor (the second stage of the voltage pump). For this purpose, electrodes of the first and the second capacitor, which are charged with charge quantities having an identical sign but different magnitudes, are momentarily short-circuited with one another. Voltages are not applied to the capacitors again until after the capacitor electrodes short-circuited with one another have been electrically isolated again.

Voltage pumps that operate according to the Dickson circuit principle are known, in particular. By a suitable choice of the bias voltages respectively applied to the capacitor electrodes, it is possible to establish as potential of the second electrode of the second (or the last) stage of the voltage pump a potential that has, with respect to the potential present at the first electrode of the first stage, a potential difference that is greater than the original supply or operating voltage after repeated pump cycles in the end state having an asymptotic profile. Although a voltage pump operating according to the Dickson principle theoretically has an efficiency of 100%, it requires a multiplicity of pump cycles, during which individual charge quantities are in each case transferred to the next higher stage, until the maximum end voltage that can theoretically be obtained is approximately achieved. Since integrated semiconductor circuits are generally operated cyclically, reference is also made to individual pump cycles in which a certain charge quantity is in each case transferred from the first pump stage as far as the last pump stage of the voltage pump. Through repeated transfer of charge quantities from the first capacitor as far as the last capacitor of the voltage pump in equidistant time segments, there is available at the output of the last pump stage (that is to say of the last capacitor of the voltage pump) practically continuously a voltage whose magnitude is significantly greater than the magnitude of the operating voltage, but is slightly smaller than the value that can theoretically be obtained, depending on the elapsed period of time since the initial pumping and depending on the intensity of the power output at the output of the voltage pump.

The known voltage pumps always function according to the principle that in order to transfer charge quantities from one capacitor to another capacitor, only two capacitors in each case are always short-circuited with one another, for example a second capacitor electrode of one capacitor being momentarily connected to a first capacitor electrode of a further capacitor. In this case, capacitor electrodes are short-circuited with one another at most in pairs. Furthermore, capacitors are always short-circuited with one another only in pairs. Consequently, at all instants at which predefined electrical potentials are applied to the capacitor electrodes, only a charge exchange between pairs of capacitors of the voltage pump is provided in each case. Although there are various modes of operation in which electrical potentials of different magnitudes are connected to the respective capacitor electrodes, these methods differ, inter alia, in that a portion of the already-pumped charge is discarded when the predefined potentials are connected. It is thereby possible to obtain a faster rise in the pump voltage that can be tapped off, but at the expense of the efficiency of the voltage pump. What is common to all conventional voltage pumps and their modes of operation, however, is that at every instant only two, generally adjacent capacitors (i.e., pump stages) are short-circuited with one another and exchange charge.

### SUMMARY OF THE INVENTION

In one aspect, the object of the present invention provides a semiconductor circuit including a voltage pump that supplies the desired pump voltage more rapidly during the pump process and that has an efficiency that is at least equal in magnitude to that of conventional voltage pumps. In another aspect, the object of the present invention provides a semiconductor circuit including a voltage pump that requires less substrate area than a conventional voltage pump. In a further aspect, the present invention provides a method for operating voltage pumps that makes it possible to provide a desired pump voltage with a shorter start-up time for running up the output voltage, as far as possible still in conjunction with a high efficiency of the voltage pump.

In various embodiments, the invention provides an integrated semiconductor circuit including a voltage pump, the voltage pump having a series circuit of capacitors, the voltage pump having first switching elements, which are connected between, in each case, two capacitors of the series circuit and effect an electrical isolation of the capacitors from one another if they are switched to a non-conducting state, the capacitors, in each case, having two capacitor electrodes, the first switching elements being connected to the capacitor electrodes of the capacitors by connecting lines, connection lines furthermore being provided, which are connected to a respective connecting line between a first switching element and a capacitor electrode and which, in each case, have a second switching element, which effects an interruption of the respective connection line if it is switched to a non-conducting state, it being possible for the second switching elements to be jointly switched to a conducting state (switched on) when all the first switching elements are switched to a non-conducting state (switched off), as a result of which each capacitor is electrically charged individually by, in each case, two connection lines, and it being possible for the first switching elements to be jointly switched to a conducting state when all the second switching elements are switched to a non-conducting state, as a result of which all the electrically-charged capacitors are electrically connected to one another.

Various embodiments of the invention provide an integrated voltage pump having a series circuit of capacitors that can all be short-circuited with one another at the same time. This has the effect of achieving for the first time a continuous potential shift from the first through to the last pump stage, that is to say from the first as far as the last capacitor of the series circuit, in the case of which the voltage that can be tapped off at the last capacitor may amount to a multiple of the operating voltage fed in. The voltage pump provided according to embodiments of the invention is thus distinguished by the fact that it is constituted and driven in such a way that when two capacitors of the series circuit are short-circuited with one another, at the same time all the other capacitors of the series circuit are also always short-circuited with one another. For this purpose, the first switching elements, which are in each case provided between two capacitors, can be switched to a conducting state simultaneously.

The voltage pump according to an embodiment of the invention furthermore contains connection lines, which are connected by circuit nodes to connecting lines that, in each case, connect a first switching element to a respective capacitor electrode. Moreover, second switching elements are provided, which interrupt a current flow along the connection lines if they are switched to a non-conducting state. According to the invention, all the first switching elements can be switched to a conducting state simultaneously, to be precise at an instant at which all the second switching elements are switched to a non-conducting state. This affects the short circuit of all the capacitors of the series circuit with one another. It is equally possible, if all the first switching elements are switched to a non-conducting state, for all the second switching elements to be switched to a conducting state simultaneously. By means of the connection line, a first and a second electrical potential can, in each case, be applied to the respective first and second capacitor electrode of the relevant capacitor of the series circuit. If all the second switching elements are switched to a conducting state simultaneously, then this leads to a simultaneous charging of all the capacitors with a voltage corresponding to the potential difference between the first and second potentials. At this instant, no charge is exchanged between the capacitors since all the first switching elements are switched to a non-conducting state at this instant. After all the second switching elements have been switched to a non-conducting state again, the first switching elements can be switched to a conducting state simultaneously relative to one another, as a result of which the capacitors are short-circuited with one another and the total voltage provided by the series circuit results from the sum of the partial voltages at the individual capacitors. Consequently, the output voltage that can be tapped off amounts to an integer multiple of the voltage difference between the first and second potentials with which each individual capacitor was previously biased. After the capacitors have been short-circuited with one another, in order to increase the potential at the end of the last capacitor, all the first switching elements can once again be switched to a non-conducting state. As a result, the capacitors are electrically isolated from one another again and thus prepared individually for the subsequent charging process of each capacitor. The next charging process then occurs upon the second switching elements being switched to a conducting state, to be precise simultaneously for all the capacitors of the series circuit. It is consequently possible, as a result of the first and second switching elements being switched to a conducting state alternately, always for a short time, for negatively-charged capacitor electrodes to be short-circuited with positively-charged capacitor electrodes, isolated from one another again and electrically charged again. Each time the first switching elements are switched to a conducting state, there is available at the output of the last capacitor a maximum voltage corresponding to the maximum achievable voltage value, provided that the load capacitance at the end of the voltage pump is sufficiently small. In contrast to conventional voltage pumps, individual charge quantities need not be pumped by repeated pumping to the respective next higher stage of the voltage pump from the first voltage pump through to the last stage. Instead, the potential at the output of the last stage is immediately brought to the maximum achievable potential level simultaneously with the opening of all the first switching elements.

It is preferably provided that each capacitor has a first capacitor electrode and a second capacitor electrode, the second capacitor electrode of a capacitor, in each case, being connected to the first capacitor electrode of the respective next capacitor of the series circuit of capacitors if the first switching elements are switched to a conducting state, and that those connection lines that are connected to a first capacitor electrode via a respective connecting line can be jointly biased with a first electrical potential, and that those connection lines that are connected to a second capacitor electrode via a respective connecting line can be jointly biased with a second electrical potential, which is different from the first electrical potential. Accordingly, all the capacitors of the voltage pump according to the invention can be recharged simultaneously, to be precise preferably with a respectively identical voltage that is uniform for all the capacitors.

It is preferably provided that when the first switching elements are switched to a non-conducting state, the second switching elements can be switched to a conducting state simultaneously relative to one another, as a result of which a voltage corresponding to the potential difference between the second electrical potential and the first electrical potential is applied individually, in each case, to each capacitor of the series circuit.

It is preferably provided that the first switching elements of the series circuit are controlled in such a way that they are switched to a non-conducting state as long as the second switching elements are switched to a conducting state and the connection lines are biased with the first electrical potential and the second electrical potential. This prevents a short circuit between two adjacent connection lines, one of which is biased with the first electrical potential and the other of which is biased with the second electrical potential, via one of the first switching elements. This would otherwise result in a short circuit and thus a power loss between different supply lines of the charge pump or the semiconductor memory. Furthermore, the capacitors, if embodied as trench capacitors, would thereby be destroyed.

It is preferably provided that when the second switching elements are switched to a non-conducting state, the first switching elements can be switched to a conducting state simultaneously relative to one another, as a result of which the capacitors are in each case conductively connected to one another. As a result, the voltage present at the individual capacitors adds up over all the capacitors to give the total output voltage that can be tapped off. The latter is not reduced by charge losses in the case of the voltage pump according to embodiments of the invention.

It is preferably provided that the second switching elements of the connection lines are controlled in such a way that they are switched to a non-conducting state as long as the first switching elements are switched to a conducting state. As a result, the output voltage is provided immediately at the end of the last pump stage and short circuits, in particular due to high voltage drops at integrated components other than the second switching elements, are avoided.

It is preferably provided that a first capacitor electrode of a first capacitor and a second electrode of a last capacitor of the series circuit are arranged at opposite ends of the series circuit of capacitors, and that a respective lead is connected to the first capacitor electrode of the first capacitor and to the second capacitor electrode of the last capacitor, as a result of which an output voltage prevailing between the first capacitor electrode of the first capacitor and the second capacitor electrode of the last capacitor can be tapped off by means of the two leads. In this case, it is provided that the second capacitor electrode of a respective capacitor is connected or can be connected to the first capacitor electrode of the adjacent or next capacitor, and vice versa. The electrical connection is effected by means of the first switching elements.

It is preferably provided that the lead connected to the first capacitor electrode of the first capacitor is connected up in such a way that it can optionally be biased with the first electrical potential or with the second electrical potential. As a result, the pump voltage that can be obtained overall can be increased even further if, after initial biasing of the first capacitor electrode of the first capacitor with the first potential, later, when the capacitors have been short-circuited among one another and the first capacitor electrode of the first capacitor has been connected to the lead, the lead is biased with the second potential (instead of with the first potential). Given n pump stages, that is to say n capacitors of the series circuit, it is consequently possible to provide a voltage of (n+1)V instead of just nV, where V represents the voltage difference between the first and second potentials.

It is preferably provided that an additional switching element is arranged within the lead connected to the first capacitor electrode of the first capacitor. Furthermore, it is preferably provided that the additional switching element can be switched to a conducting state jointly with all the first switching elements and can be switched to a non-conducting state jointly with all the first switching elements. The additional switching element can be switched to a conducting state particularly when the second switching elements are switched to a non-conducting state. As a result of the simultaneous switching on of all the first switching elements and also of the additional switching element, the first electrode of the first capacitor of the series circuit is connected to the lead biased with the second (instead of the first) potential and the output potential that can be tapped off at the last capacitor is pumped by a magnitude corresponding to the voltage difference between the first and second potentials, which are applied to the respective electrodes.

It is preferably provided that the integrated semiconductor circuit drives the series circuit of the voltage pump in such a way that either all the first switching elements, if appropriate simultaneously with the additional switching element, and all the second switching elements are jointly switched to a conducting state alternately. In particular, this avoids a situation in which both first and second switching elements can be open simultaneously at one point in time, which would result in short circuits or a charge loss.

It is preferably provided that the capacitors of the series circuit are integrated trench capacitors. Trench capacitors (deep trench capacitor) withstand only relatively low voltages; at higher voltages they age prematurely, lose their specified electrical properties and lead to increased leakage currents. Therefore, trench capacitors cannot be operated reliably at higher voltages. Therefore, conventional trench capacitors cannot be used for voltage pumps; instead, conventional integrated voltage pumps exclusively use diffusion capacitors. The voltage pump according to embodiments of the invention enables the operationally reliable use of trench capacitors for the purpose of voltage amplification. This is due to the fact that only the potential difference between the first and second potentials is present at each capacitor and, consequently, at an individual capacitor there is never a higher voltage present than the permitted voltage up to which the proper electrical behavior and the promised service life of the capacitor are guaranteed.

One advantage of using trench capacitors consists in the resultant space saving on the semiconductor chip. Conventional voltage pumps formed with the aid of diffusion capacitors take up a considerable proportion of the chip area. Trench capacitors that save more space are conventionally provided only in the memory cell array and, moreover, cannot be used in an operationally reliable manner in conventional voltage pumps owing to the higher voltages. By contrast, the voltage pump according to the invention can be realized with trench capacitors; the latter operate in an operationally reliable manner within the voltage pump according to the invention. This would not be the case with voltage pumps having conventional driving if trench capacitors were used for the capacitors.

What is more, the construction of the voltage pump according to embodiments of the invention also requires a less comprehensive driving circuit than a conventional voltage pump. This is already evident from the fact that the voltage pump according to embodiments of the invention only requires two different cycle times per cycle.

It is preferably provided that the first switching elements and the second switching elements are in each case integrated transistors, in particular field effect transistors. The field effect transistors also withstand higher voltages in contrast to trench capacitors; the design as MOSFETs (Metal Oxide Semiconductor Field Effect Transistor) does not require any novel microelectronic components whatsoever for the construction of the voltage pump used according to embodiments of the invention.

It is preferably provided that all the capacitors of the series circuit are dimensioned in such a way that they have a capacitance of identical magnitude. This is also advantageous because the efficiency of the voltage pump according to embodiments of the invention is greatest with a capacitance that is uniform for all the capacitors.

It is preferably provided that the semiconductor circuit has a first series circuit and a second series circuit of capacitors with first switching elements, which are connected to the capacitors by connecting lines, and with second connection lines, which have second switching elements and are connected to the connecting lines, the last capacitor of the first series circuit and the last capacitor of the second series circuit, in each case, being connected to a switching unit connected to an output line for forwarding an increased pump voltage.

A semiconductor circuit comprising a voltage pump that has two mutually assigned series circuits of, in each case, the same number of capacitors is consequently provided. Both series circuits are constructed and can be driven in the same way, but it is preferably provided that with regard to the alternate opening, that is to say switching on, of the first and second switching elements, the second series circuit is operated in antiphase with respect to the first series circuit.

Accordingly, it is provided that the semiconductor circuit drives the two series circuits of capacitors in such a way that the first switching elements of the first series circuit are switched to a conducting state simultaneously with the second switching elements of the second series circuit and that, in each case, the first switching elements of the second series circuit are switched to a conducting state simultaneously with the second switching elements of the first series circuit. In this case, during those time cycles in which the capacitors are charged in the first series circuit, in the second series circuit the capacitors thereof are short-circuited with one another, that is to say that the output potential of the second series circuit is pumped up, and the opposite holds true in the intervening time cycles, so that the two series circuits alternate with one another with regard to their functions “precharging the capacitors” and “pumping the output voltage.” By virtue of the additional second series circuit, the desired output voltage can thus be provided by the second series circuit in those cycle times in which the capacitors of the first series circuit are recharged.

For this purpose, it is provided that the output-side capacitor electrodes of the respective last capacitors of the two series circuits are connected to a switching unit connected to an output line for deriving the output voltage.

It is preferably provided that the switching unit cyclically connects, in each case, either the last capacitor of the first series circuit or the last capacitor of the second series circuit to the output line, the switching unit, in each case, connecting the last capacitor of that series circuit to the output line whose electrical potential has the respectively greater potential difference with respect to the first potential. In general, the output potential of one of the two series circuits corresponds to the maximum potential, that is to say an integer multiple of the voltage previously applied to each individual capacitor, if appropriate plus the pump voltage having the same magnitude. At the intervening cycle times, the output potential of the relevant series circuit is closer to the first potential or is equal to the first potential. The voltage pump according to embodiments of the invention thus has at least one series circuit of capacitors, each series circuit having at least two capacitors. The series circuit or the series circuits preferably has or have three capacitors or else more than three capacitors that can simultaneously be connected in series.

In other embodiments, the invention provides a method for operating a semiconductor circuit including a voltage pump having at least one series circuit of capacitors, first switching elements interposed between in each case two capacitors, and also connection lines, which are connected to connecting lines connecting in each case a first switching element and a capacitor electrode of a capacitor to one another and in each case have a second switching element, which effects an interruption of the respective connection line in the switched-off state, the semiconductor circuit being operated in such a way that the capacitors of the series circuit of capacitors are short-circuited with one another in periodic time slots and, between the periodic time slots, are in each case simultaneously charged individually with a voltage.

It is preferably provided that for the purpose of short-circuiting the capacitors of the series circuits with one another, in each case, all the first switching elements of the series circuit are switched to a conducting state, while all the second switching elements of the series circuit are switched to a non-conducting state. In particular, it is provided that the first switching elements are temporarily switched to a conducting state only when the second switching elements are switched to a non-conducting state. If the switching elements are transistors, for example, field effect transistors, the switched-on state corresponds to a current flow between the two source/drain regions, whereas the switched-off state corresponds to that state in which the formation of a transistor channel is prevented.

It is preferably provided that for the purpose of simultaneously charging all the capacitors of the series circuit, in each case, all the second switching elements are switched to a conducting state, while all the first switching elements are switched to a non-conducting state. In particular, it is provided that the second switching elements are temporarily switched to a conducting state only when the first switching elements are turned off.

It is preferably provided that a semiconductor circuit is operated with a voltage pump whose capacitors, in each case, have a first capacitor electrode and a second capacitor electrode, the second capacitor electrode of a capacitor, in each case, being connected to the first capacitor electrode of the next capacitor if the first switching elements are switched to a conducting state, and that for the purpose of simultaneously charging all the individual capacitors of the series circuit, in each case all the first capacitor electrodes are biased with a first electrical potential and all the second capacitor electrodes are biased with a second electrical potential, which is different from the first electrical potential. Consequently, each capacitor of the series circuit is individually charged with a uniform voltage before it is connected to the adjacent capacitors via the first switching elements.

It is preferably provided that the first capacitor electrodes and second capacitor electrodes of the capacitors are in each case biased with the aid of the connection lines.

It is furthermore preferably provided that an output voltage generated by the series circuit of capacitors is tapped off via two leads connected to the first capacitor electrode of the first capacitor and to the second capacitor electrode of the last capacitor of the series circuit.

It is preferably provided that when all the capacitors of the series circuit are short-circuited with one another, an additional switching element, which connects the first capacitor electrode of the first capacitor of the series circuit to the lead connected thereto, is switched to a conducting state simultaneously with all the first switching elements of the series circuit, while the lead is biased with the second electrical potential. In this case, as a result of a change in potential of the lead previously biased with the first potential to the second potential, the output voltage is pumped by the difference magnitude between the second and first voltages, namely when the additional switching element is turned on. With the second switching elements switched to a non-conducting state, the additional switching element can also be switched to a conducting state before the first switching elements are switched to a conducting state. However, it is expedient and saves additional cycle times if the additional switching element is switched to a conducting state simultaneously with all the first switching elements of the series circuit of capacitors.

It is preferably provided that a semiconductor circuit is operated with two series circuits of capacitors assigned to one another whose respective last capacitors are connected to a switching unit, first switching elements of the second series circuit always being switched to a conducting state simultaneously with the second switching elements of the first series circuit and second switching elements of the second series circuit always being switched to a conducting state simultaneously with the first switching elements of the first series circuit. Consequently, the charging of the capacitors of the first series circuit is always effected simultaneously with the short-circuiting of the capacitors of the second series circuit among one another, and vice versa.

It is preferably provided that the switching unit is controlled in such a way that it biases an output line connected to the switching unit alternately with the output-side potential of the first series circuit and with the output-side potential of the second series circuit. The output-side potential of the relevant series circuit is, in each case, provided by the second capacitor electrode of the last capacitor of the relevant series circuit.

In particular, it is provided that the switching unit biases the output line in each case with the output-side potential of that series circuit that has the greatest potential difference with respect to the first electrical potential. Consequently, each series circuit determines the potential of the output line in those cycle times at which a potential is present which has arisen as a result of all the capacitors of the series circuit being short-circuited.

Finally, it is preferably provided that the switching unit biases the output line with a potential that has, with respect to the first electrical potential, a potential difference corresponding to an integer multiple of the potential difference between the first electrical potential and the second electrical potential. In the case of an additional pumping of the input-side lead from the first to the second potential, the output potential is increased by a potential difference of identical magnitude.

### BRIEF DESCRIPTION OF THE DRAWINGS

The invention is described below with reference to the figures, in which:

FIG. 1 shows a schematic plan view of a conventional voltage pump at different cycle times;

FIG. 2 shows an integrated semiconductor circuit comprising a voltage pump according to the invention;

FIG. 3 shows the integrated semiconductor circuit comprising the voltage pump according to the invention from FIG. 2 at a different cycle time;

FIG. 4 shows a development of the voltage pump according to the invention;

FIG. 5 shows a simulation of the switching behavior of the voltage pump according to the invention;

FIG. 6 shows an exemplary embodiment with regard to the circuitry realization of the voltage pump from FIGS. 2 and 3;

FIG. 6A shows the temporal profile of an output voltage of the voltage pump in accordance with FIG. 6; and

FIGS. 6B to 6D show control signals for driving the voltage pump in accordance with FIG. 6.

The following list of reference symbols can be used in conjunction with the figures:
1 Semiconductor circuit
3 Connecting line
4; 4a, 4b Connection line
5, 6 Lead
8 First capacitor electrode
9 Second capacitor electrode
10 Voltage pump
11, 21 First switching element
12, 22 Second switching element
13 Additional switching element
14 Switching unit
15 Output line
18 First capacitor electrode of the first capacitor
19 Second capacitor electrode of the last capacitor
C; C′ Capacitor
C1; C1′ First capacitor
CA Load capacitance
Cn; Cn′ Last capacitor
R Series circuit
R1 First series circuit
R2 Second series circuit
S1, . . . , S5 Control signal
T; T′ Cycle time
V Voltage
Va Initial potential
V0 First electrical potential
V1 Second electrical potential
Vn New potential
V′ Output voltage

### DETAILED DESCRIPTION OF ILLUSTRATIVE EMBODIMENTS

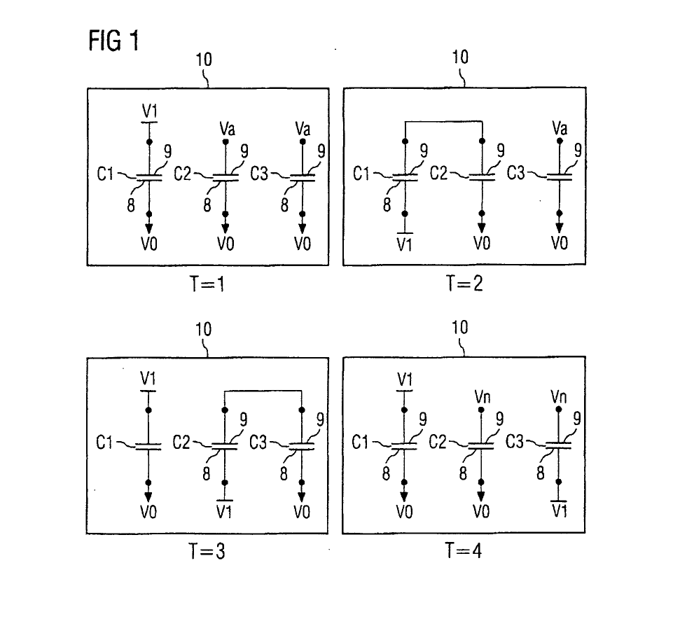

FIG. 1 schematically shows a conventional voltage pump 10, which is usually formed as part of an integrated semiconductor circuit. The conventional voltage pump 10 is illustrated at four different cycle times T in FIG. 1, in order to elucidate the mode of operation of the voltage pump. The voltage pump 10 has (for example three) capacitors C1, C2, C3 each having a first capacitor electrode 8 and a second capacitor electrode 9. The capacitor electrodes 8, 9 can be biased with variable potentials, for example, with a first electrical potential V0 or a second electrical potential V1. The basic principle of a conventional voltage pump consists in the charge stored in a capacitor being transferred in part progressively to the respective next capacitor until the last capacitor on the output side is raised or lowered to a potential that has a greater potential difference with respect to the input-side potential at the first capacitor of the voltage pump 10 than the potential difference between the available potentials V0, V1. The potentials V0, V1 may be, for example, the electrical potentials of the two terminals of the supply voltage of the semiconductor circuit or a partial region of the semiconductor circuit. The two potentials V0, V1 may equally be potentials with which specifically the voltage pump 10 is supplied.

Voltage pumps that function according to the principle indicated above are based on the Dickson circuit principle. For such voltage pumps it is possible to calculate the maximum output voltage that can be obtained between the first and last capacitors of the voltage pump 10. Such conventional voltage pumps are operated in the manner such that the four different bias voltages of the transistors that are indicated in FIG. 1 are applied periodically in a cyclic order at the four cycle times T=1, T=2, T=3 and T=4, as a result of which the output voltage that can be tapped off rises almost to the desired value in a short time.

At the instant of an arbitrarily chosen cycle time T=1, by way of example, a first potential V0 is applied to a respective capacitor electrode of each capacitor C1, C2, C3, for example, to the first capacitor electrodes 8 thereof. A second potential V1, which is different from the first potential, is applied to the second capacitor electrode 9 of the first capacitor C1 at the same time. At this instant, the second capacitor electrodes 9 of the remaining voltage pumps C2, C3 are biased with initial potentials Va that arose as a result of the previous pass through the cycle formed from the four cycle times T. At the instant of the cycle time T=1, the remaining electrodes are biased with the corresponding first electrical potential V0 or the second electrical potential V1.

At a later cycle time T=2, the second capacitor electrode 9 of the first capacitor C1 of the voltage pump is short-circuited with a capacitor electrode 9 of the next, in this case second, capacitor C2, a uniform potential being established on the capacitor electrodes 9 that are short-circuited with one another. At the same time, the potential at the first electrode 8 of the first capacitor C1 is brought to that potential V1 that was previously applied to the opposite electrode 9 of the first capacitor C1. By way of example, the second potential V1 may be greater than the first potential V0; in this case, at the cycle time T=2, the first electrode 8 of the first capacitor C1 is brought from the first potential V0 to the higher potential V1. The electrodes of the first and second capacitors C1, C2 that are short-circuited with one another now have an electrical potential that is greater than the second potential V1. This results from the fact that the second capacitor electrode 9 of the first capacitor C1 was biased (for example, positively) with respect to the first electrode 8 of the first capacitor at the instant of the cycle time T=1 and the potential of the first electrode 8 of the first capacitor C1 is additionally raised from V0 to V1 at the cycle time T=2. Since the electrical potential of the second electrode 9 of the first capacitor C1 is also furthermore greater than that of the first electrode 8, it has a potential above V1. Since the charge shifted by the pumping is also distributed to the capacitor electrode 9 of the second capacitor C2, however, the potential rise of the second capacitor electrode 9 of the second capacitor C2 is less than the potential difference between V1 and V0.

At the cycle time T=3, the second capacitor C2 is isolated from the first capacitor C1 again and the first capacitor is biased as at the cycle time T1. A capacitor electrode 9 of the second capacitor C2 and a capacitor electrode 9 of the third (and in this case last) capacitor C3 of the voltage pump 10 are now short-circuited. At the same time, the potential of the first capacitor electrode 8 of the second capacitor C2 is now raised from V0 to V1. The potential of the second capacitor electrode 9 of the second capacitor C2, which previously was already greater than V1, is increased further by this pumping and the short circuit with respect to the capacitor electrode 9 of the third capacitor C3 leads to a corresponding increase in the potential of the capacitor electrode 9 of the last capacitor C3. At the cycle time T4, all the capacitor electrodes 8, 9 of the capacitors C1, C2, C3 are electrically isolated from one another again, and at the capacitor electrodes 9—previously short-circuited with one another—of the last two capacitors C2, C3 of the voltage pump 10, a new potential Vn is present, which is greater than that initial potential Va that prevailed at these two electrodes 9 of the last two capacitors C2, C3 at the end of the previous cycle of the four cycle times T. Consequently, the output-side potential at the last capacitor C3 of the voltage pump 10 has been increased as a result of passing through the four cycle times T=1 to T=4. A contribution is also made to this by the fact that the potential of the first electrode 8 of the last capacitor C3 was raised from V0 to V1 at the cycle time T=4.

It can thus be discerned with reference to FIG. 1 that a conventional voltage pump requires a plurality of steps that are to be successively passed through periodically and, after being cyclically passed through sufficiently often, gradually provide an increased output voltage that converges asymptotically toward the theoretically calculable maximum value of the output voltage of a Dickson voltage pump. What is disadvantageous about the voltage pump illustrated above is the multiplicity of different operating states or cycle times that are passed through successively until a voltage applied to the first capacitor C1 (that is to say the first capacitance of the voltage pump) contributes to increasing the output voltage at the last capacitor C3 of the voltage pump. It is furthermore disadvantageous that the efficiency of a Dickson voltage pump becomes lower, the more stages, that is to say the more capacitors, it has.

A particular disadvantage is evident from the fact that, as can be discerned in FIG. 1 at the cycle time T=3, a voltage that is greater than the operating voltage fed in or the predetermined voltage difference between an available first potential V0 and an available second potential V1 may be present at an individual capacitor C3 of the voltage pump 10. Capacitors are usually produced technologically as stacked capacitors or as trench capacitors (deep trench capacitors). Capacitors formed as trench capacitors withstand only a limited maximum voltage, however, to prevent them from being destroyed by these voltages or producing leakage currents with a magnitude that cannot be afforded tolerance. The voltage present at the last capacitor C3 of the voltage pump 10 at the cycle time T=3 is, however, considerably greater than the operating voltage V, that is to say the potential difference between V1 and V0, with the result that for voltage pumps in accordance with FIG. 1 or similar modifications of voltage pumps, the capacitors must be formed exclusively as stacked capacitors. However, this takes up an unnecessarily large amount of substrate area on the semiconductor substrate in which the voltage pump is formed individually or as part of the integrated semiconductor circuit.

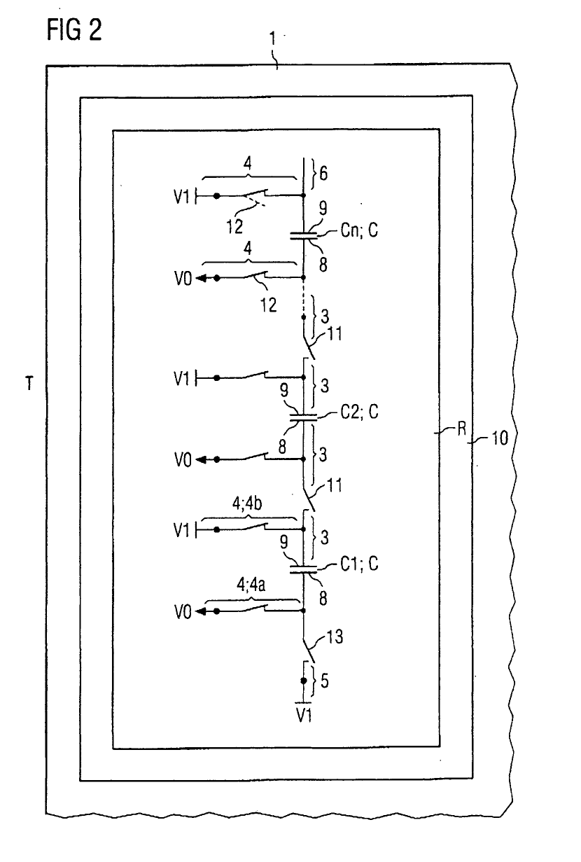

FIG. 2 shows a schematic plan view of a semiconductor circuit 1 comprising a voltage pump 10 according to embodiments of the invention. According to embodiments of the invention, the voltage pump 10 has a series circuit R of capacitors C1, C2, . . . , Cn or C. The capacitors C in each case have a first capacitor electrode 8 and a second capacitor electrode 9 and are connected in series with one another, the series circuit additionally having first switching elements 11 interposed between, in each case, two capacitors C of the series circuit R. The first switching elements 11 are schematically illustrated as electrical switches in FIG. 2 and may be formed, for example, as transistors, for example as transistors of MOSFET design. The transistors or the first switching elements 11 produce or interrupt the electrical connection between, in each case, two capacitor electrodes of adjacent capacitors C, depending on the switching state. Each capacitor electrode 8, 9 of one of the capacitors C1, . . . , Cn is connected to a respective first switching element 11 by a connecting line 3.

The voltage pump 10 according to embodiments of the invention furthermore has connection lines 4, which are connected to a corresponding connecting line 3 by a respective circuit node. The connection lines 4 serve for feeding predetermined potentials V0 and V1 to the capacitor electrodes 8, 9, and can, therefore, be biased with a first potential V0 and a second potential V1. In particular, those connection lines 4a that are connected via a corresponding connecting line 3 directly to a first capacitor electrode 8, illustrated at the bottom in FIG. 2, of a capacitor C can be biased with the first potential V0, whereas the remaining connection lines 4b connected to the second capacitor electrodes 9 can be biased with a different, second potential V0. Second switching elements 12, which enable or interrupt a current flow along the connection lines 4 depending on the switching state, are provided within or at the end of the connection lines 4. FIG. 2 illustrates the series circuit R of the voltage pump 10 in a state and at a cycle time T at which all the first switching elements 11 are switched to a non-conducting state and all the second switching elements 12 are switched to a conducting state. As a result, all the capacitors C of the series circuit R are electrically decoupled from one another. At the same time, all the first and second capacitor electrodes 8, 9 of all the capacitors C are connected to either the first electrical potential V0 or the second electrical potential V1. As a result, within the series circuit, all the capacitors C1, C2, . . . , Cn are, in each case, individually charged in the same way as an individual, isolated capacitor is charged conventionally. As a result, the voltage difference between V1 and V0 is, in each case, present at the two capacitor electrodes of each capacitor C; this voltage is in no way reduced by voltage shifts such as occur with respect to the supply voltage in the case of a Dickson voltage pump.

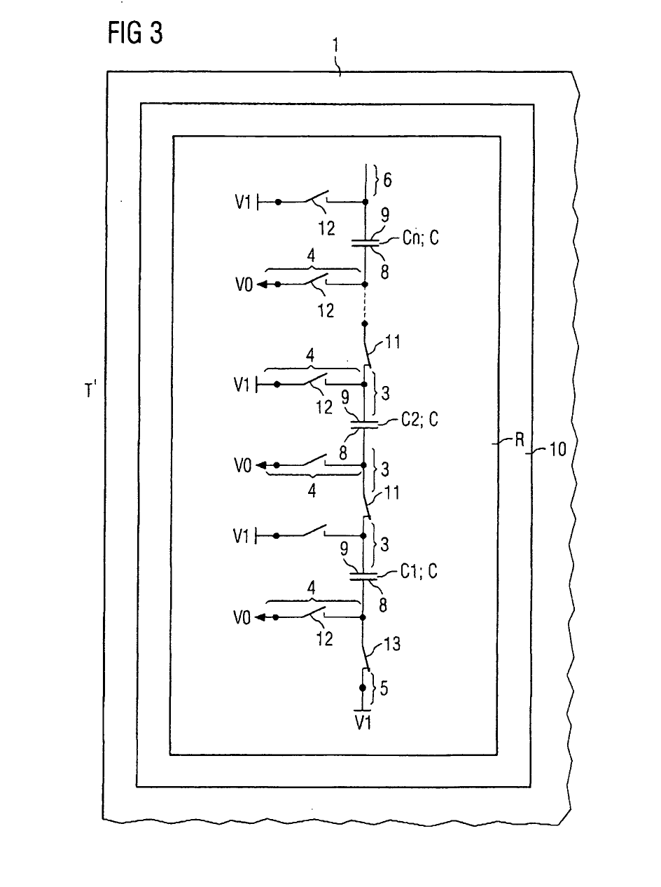

FIG. 3 shows the semiconductor circuit 1 illustrated in FIG. 2 and comprising the voltage pump 10 according to the invention, the series circuit R of which, however, is now illustrated during the different, second cycle time T′. At this cycle time T′, all the first switching elements 11 are switched to a conducting state and in return all the second switching elements 12 are switched to a non-conducting state. As a result, the capacitor electrodes 8, 9 are in each case electrically decoupled from the predetermined electrical potentials V0, V1. The switched-on first switching elements 11 simultaneously establish the electrical connection between the mutually facing capacitor electrodes of, in each case, two adjacent capacitors C. As a result, all the capacitors C1, C2, . . . , Cn are now connected in series, so that the potential differences that are present at the respective capacitors C and that in each case amount to V=V1−V0 are cumulated. The output voltage that can be tapped off between the first capacitor electrode 8 of the first capacitor C1 and the second capacitor electrode 9 of the last capacitor Cn thus amounts to n times the potential difference V between V1 and V0, where n corresponds to the number of capacitors C in the series circuit R. Consequently, an output voltage that is significantly higher than the maximum achievable output voltage of a Dickson circuit pump is obtained in a simpler manner than in the case of the Dickson voltage pump by means of the voltage pump according to the invention. Moreover, the voltage pump represented in FIGS. 2 and 3 only requires two different cycle times T, T′ that are passed through in an alternate order. As a result, the desired output voltage is achieved much more rapidly and more efficiently than in the case of a conventional voltage pump. The voltage pump according to embodiments of the invention furthermore has the advantage that it can generate far higher output voltages than a conventional voltage pump, in the case of which the efficiency decreases further and further as the number of stages, i.e., capacitors, increases. Even compared with alternative conventional voltage pumps that pump more rapidly and the efficiency of which is typically approximately 33%, the voltage pump according to embodiments of the invention obtains a comparatively high efficiency of 50%. A particular advantage of the voltage pump according to embodiments of the invention is that voltages corresponding at most to the potential difference between the first and second potentials V0, V1 provided are in each case present at all the capacitors C of this voltage pump. At no point in time is a greater potential difference present at any of the capacitors C of the voltage pump according to the invention. Therefore, the voltage pump according to embodiments of the invention is the first voltage pump that can be operated reliably within an integrated semiconductor circuit with the aid of trench capacitors. For practical purposes, the series circuit of the voltage pump is preferably formed from two or three capacitors C, but in order to generate even higher voltages it is also possible to provide more than three capacitors C in the series circuit R of the voltage pump 10 according to the invention.

In addition, the voltage pump according to embodiments of the invention may have an additional switching element 13, which can be switched to a conducting state and off in each case simultaneously with the first switching elements 11. As a result, the first capacitor electrode 8 of the first capacitor C1 can be connected to a lead 5 biased with the second potential V1 when the first switching elements 11 are switched to a conducting state and connect all the capacitors C to one another. As a result of the additional switching element 13 being switched to a conducting state simultaneously, the potential of the first capacitor electrode 8 of the first capacitor C1 is raised from initially V0 to then V1, that is to say to the second potential. Previously, the input-side first capacitor electrode 8 was biased with the first potential V0 via the corresponding connection line 4 and via the switched-on second switching element 8. As a result of the potential alteration now effected on the input side at the first capacitor C1, the supply voltage that can be tapped off at the entire series circuit is increased again by the magnitude V=V1−V0, that is to say that the output voltage is additionally pumped.

The voltage pump according to the invention is periodically and alternately successively put respectively into the switching states in accordance with the cycle times T and T′, so that alternately all the first switching elements 11 (jointly with the additional element 13) and all the second switching elements 12 are jointly switched to a conducting state momentarily. Charging of all the capacitors individually and short-circuiting of all the capacitors of the series circuit R are thereby achieved in each case in an alternate order.

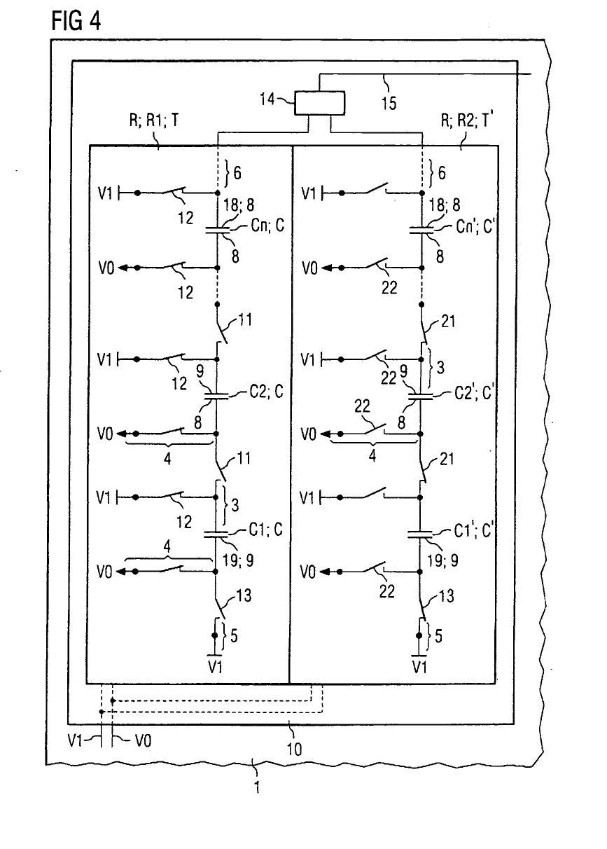

FIG. 4 shows a development of the voltage pump 10 according to the invention that has two series circuits R1 and R2, each series circuit R1, R2 of which is formed in the same way as the series circuit R illustrated in FIGS. 2 and 3. Both series circuits have input-side and output-side leads 5, 6, at which a pump voltage can be tapped off that is generated by the respective series circuit R1, R2 of capacitors C1 to Cn and C1′ to Cn′. Within the voltage pump 10, each of the two series circuits is supplied with the first predetermined potential V0 and the second predetermined potential V1.

The two series circuits R1, R2 are operated in such a way that the two series circuits are operated in different switching states at every point in time. At all (for example even-numbered) cycle times at which the series circuit R1 is in the switching state in accordance with FIG. 2, the series circuit R2 is in the switching state in accordance with FIG. 3. Conversely, for instance at all odd cycle times, the series circuit R2 is in the switching state in accordance with FIG. 2 and the series circuit R1 is always at the same time in the switching state in accordance with FIG. 3. Consequently, the two series circuits R1, R2 are operated in antiphase with respect to one another with regard to the cycle that is formed from only two cycle times T, T′ and is passed through periodically by the two series circuits. The series circuit R2 passes through this cycle in each case with a temporal offset with respect to the series circuit R1. This means that whenever the first switching elements 11 of the series circuit R1 are switched to a conducting state and the second switching elements of the series circuit R1 are switched to a non-conducting state, at the same time the first switching elements 21 of the series circuit R2 are switched to a non-conducting state and the second switching elements 22 of the series circuit R2 are switched to a conducting state. In each case, one cycle time thereafter, the switching elements of the two series circuits are switched in the manner illustrated in FIG. 4. As a result, the output potential V′=(n+1)V is, in each case, provided alternately at the output-side leads 6 of the two series circuits R, to be precise in each case during a cycle time T; T′ or a cycle duration, which is dimensioned to be longer but it is uniform. As in FIGS. 2 and 3 as well, it is likewise possible in the case of the developed voltage pump 10 in accordance with FIG. 4 for the input-side capacitors C1, C1′ to be pumped to a higher potential with the aid of additional switching elements 13.

The output-side lines 6 of the two series circuits R1, R2 are connected to two inputs of a switching unit 14, which cyclically alternately short-circuits the output line 15 of the voltage pump 10 with one of the lines 6. As a result, in each case the lead 6 of that series circuit R1; R2 is connected to the output line 15 which is currently biased in each case with a potential having the greater potential difference with respect to the first potential V0. This ensures that at every point in time that series circuit at which the maximum pump voltage can be tapped off is always connected to the output line 15, while the respective other series circuit is electrically decoupled from the output line 15 in order to charge its capacitors C or C′ again in this time. As an alternative, however, instead of the switching unit 14 it is possible to provide a circuit node via which the output-side lines 6 of both series circuits are directly connected to the output line 15.

FIG. 5 shows a simulation of the electrical switching behavior of the voltage pump according to the invention comprising a series circuit in accordance with FIG. 2 and FIG. 3. The profile of the development of the output voltage V′ between the leads 5, 6 at the first and last capacitors of the series circuit R is plotted as a function of the time t, which is plotted over a time period of approximately 65 cycle times, to be precise respectively for the case of a load capacitance CA of 10 nanofarads (nF) and 30 nF. After approximately 0.9 ms, the output voltage V′ has largely been set to the maximum value that can be achieved asymptotically, the asymptotic approximation by its nature proceeding more slowly for the case of a load capacitance of 30 nF. It can be discerned from both of the simulated potential profiles that the output voltage V′ in each case stagnates at every second cycle time since the first switching elements are switched to a non-conducting state and the capacitors are in each case individually charged again. The switching on of the first switching elements at the remaining cycle times is manifested in FIG. 5 by the respective rise in the output voltage V′ by a certain magnitude, which decreases as the number of cycles that have been passed through increases, and tends toward zero in the course of the asymptotic approximation to the maximum potential of 4.8 V, for example. A functional and optimized voltage pump is thus provided with the aid of two such series circuits that are operated in oppositely cyclic fashion and the output signals of which are alternately connected to the output line by the switching unit 14 from FIG. 14.

With the aid of the voltage pump according to embodiments of the invention, all the capacitors can, in each case, be charge individually (by means of so-called “precharging”). The first potential V0 may be, for example, a ground potential or any other reference potential. The voltage pump simulated in FIG. 5 has, by way of example, two series-connected capacitors that, in each case, have a capacitance of identical magnitude and are, in each case, charged with 1.6 V during each charging process. Furthermore, the voltage was increased to a total of 4.8 V (instead of 3.2 V) by means of boosting by an additional switching element 13.

The voltage pump according to the invention may furthermore be a voltage pump comprising three or more series-connected capacitors per series circuit. Their capacitors may be formed as trench capacitors whose outer electrodes are optionally formed by p-type dopant diffusion regions or by n-type dopant diffusion regions in the substrate. The voltage pump according to the invention makes it possible to generate output voltages that are significantly higher than the permissible maximum voltage that is allowed to be present, in each case, at a single capacitor. The first and second switching elements of both series circuits may be, for example, n-channel field effect transistors of p-channel field effect transistors.

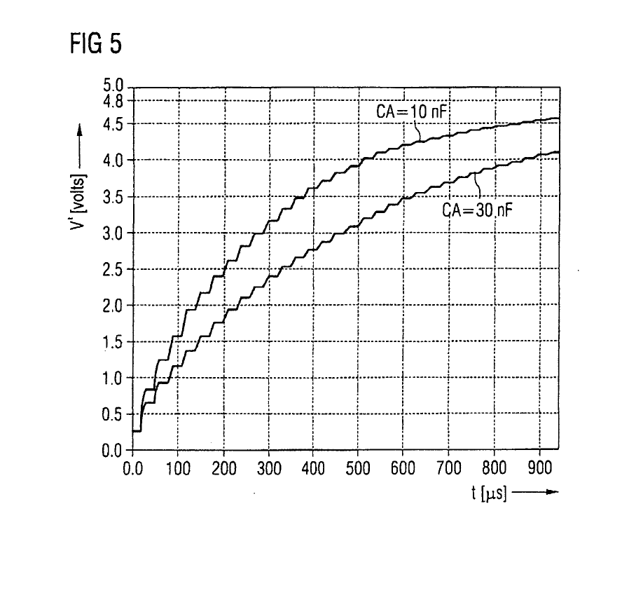

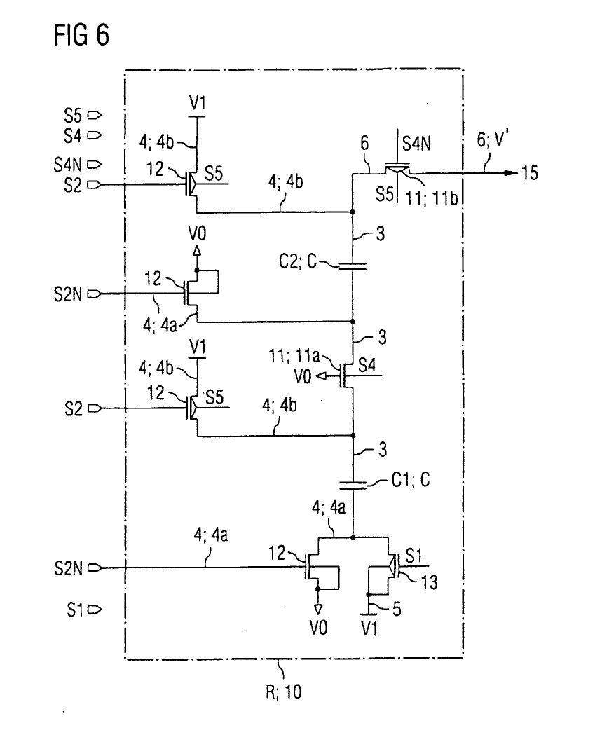

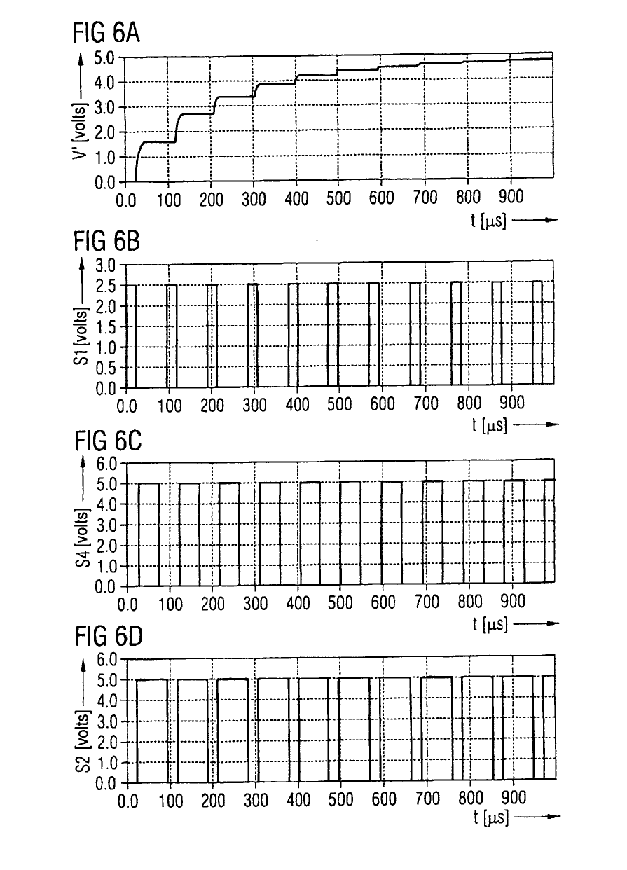

FIG. 6 shows an exemplary embodiment with regard to the circuitry realization of a series circuit of the voltage pump according to the invention. The series circuit R of the voltage pump 10 corresponds to the series circuit illustrated in FIGS. 2 and 3. In addition, FIG. 6 shows by way of example a possible way of realizing the switching elements 11, 12 and also the driving by electrical signals that will be explained below with reference to FIGS. 6A to 6D. The series circuit R in FIG. 6 has two capacitors C or C1, C2, which are connected in series with one another and are isolated from one another by a first switching element 11a. A further first switching element 11b is furthermore illustrated at the end of the series circuit, the switching element not being illustrated in FIGS. 2 and 3 merely for reasons of clarity. The further first switching element 11b is arranged in the output-side lead 6 leading to an output line 15 for outputting the pumped voltage. The connection lines 4 have second switching elements 12, which are switched to a conducting state for charging the capacitors C. Furthermore, FIG. 6 illustrates the additional switching element 13, which is switched to a conducting state and off concurrently with the first switching elements 11a, 11b.

In the exemplary embodiment of FIG. 6, that first switching element 11a, which is arranged between the two capacitors C1, C2, is formed as an n-MOSFET (n-channel field effect transistor), in the same way as those second switching elements 12 that are provided at those connection lines 4a by means of which capacitor electrodes are biased with the first electrical potential V0. The rest of the second switching elements 12, which are provided in those connection lines 4a by means of which capacitor electrodes are biased with the second electrical potential V1, are formed as p-MOSFETs (metal oxide semiconductor field effect transistor), that is to say as p-channel field effect transistors, in the exemplary embodiment of FIG. 6. The additional switching element 13 and also the further first switching element 11b, which is arranged in the output-side lead 6, are likewise formed as p-MOSFETs.

The series circuit R generates the output voltage V′, which, in a plurality of cycles, asymptotically approximates to a maximum value of 5 V, for example, as is illustrated in FIG. 6A. FIG. 6A shows the temporal profile of the output voltage V′, measured in volts, as a function of the time, which is in each case plotted in units of 100 microseconds jointly for FIGS. 6A to 6D. As already explained with reference to the figures above, the potential of the output-side lead 6 is pumped up step-by-step by the series circuit R. After each cycle (which manages with a minimum number of just two cycle steps), the potential of the output-side lead 6 is increased by a certain magnitude. The further first switching element 11b is controlled by a control signal S4N applied to the gate electrode of the further first switching element 11b. The control signal S4N is inverted relative to the control signal S4, which is plotted in FIG. 6C. This means that along the time scale t in FIG. 6C, whenever the control signal S4 assumes the maximum value of, for example, 5 V (alternatively 6 V or some other voltage), the inverted signal S4N assumes the value of 0 V, whereas whenever the control signal S4 assumes the value of 0 V, the inverted control signal S4N assumes the maximum value of 5 V (or a corresponding different maximum voltage, for example of 6 V).

Since the further first switching element 11b is a p-channel field effect transistor, the transistor is turned on precisely when a low electrical potential is present at its gate electrode, that is to say the control signal S4N assumes a small value. This is the case precisely when the signal S4 assumes a large value, in particular a large positive value. For example, whenever the signal S4 illustrated in FIG. 6C assumes the value of 5 V, the inverted signal S4N is in each case 0 V and switches on the further first switching element 11b. This takes place, as can be discerned from FIG. 6C, for the first time after approximately 25 microseconds. The first voltage rise of the output signal V′ in FIG. 6A takes place precisely at this instant. After approximately a further 90 microseconds in each case, a further voltage swing of the output signal V′ ensues, but it turns out to be smaller and smaller, the further the pumping process has progressed and the closer the output voltage is to the end voltage that can be achieved asymptotically. Comparison of FIGS. 6A and 6C reveals that after a respective clock period, that is to say after a respective falling and rising clock edge of the signal S4, the respective next voltage swing of the output signal V′ (FIG. 6A) is initiated. The further first switching element 11b illustrated in FIG. 6 thus serves to isolate the output-side end of the lead 6 from the input-side end of the lead 6 during the charging of the capacitors C and, on the other hand, in each case when the capacitors C are short-circuited with one another, to establish a conductive connection of the series circuit to the output line 15.

In order to prevent leakage currents due to forward-biased pn junctions in the field effect transistors, the substrate region thereof is biased with a temporally constant, high positive potential, namely with the control signal S5, as illustrated in FIG. 6. The same temporally constant control signal S5 is also applied to the substrate terminals of those second switching elements 12 that are arranged in connection lines 4b via which capacitor electrodes can in each case be biased with the second electrical potential V1. Leakage currents are thereby prevented from arising in the case of these p-channel field effect transistors, too. The electrical connection between the substrate regions of these three p-channel field effect transistors and the common potential terminal for the control signal S5 (top left in FIG. 6) is not illustrated in FIG. 6 for the sake of clarity.

A first switching element 11a is arranged between the two capacitors C1, C2 of the two-stage voltage pump 10, the first switching element here being formed as a p-channel field-effect transistor. The substrate region thereof is biased with the first electrical potential V0. The temporally variable control signal S4, which has already been explained with reference to FIG. 6C, serves for electrically driving the gate electrode of the first switching element 11a. The two first switching elements 11a, 11b are always switched to a conducting state at the same time. In this case, the gate electrode of the first switching element 11a is supplied with the control signal S4 and the gate electrode of the further first switching element 11b is supplied with the inverted control signal S4N. This takes account of the fact that the first switching element 11a is an n-channel field effect transistor, whereas the further first switching element 11b is a p-channel field effect transistor. Consequently, both first switching elements 11a, 11b are switched to a conducting state or off simultaneously in each case.

The additional switching element 13 serves for boosting the voltage, the potential of the first capacitor electrode—illustrated at the bottom in FIG. 6—of the capacitor C1 always being raised from the first potential V0 to the second potential V1. For this purpose, the additional switching element 13 is switched to a conducting state in each case simultaneously with the first switching elements 11a, 11b. For this purpose, a further control signal S1 is provided, with which the gate electrode of the additional switching element 13 is supplied. The control signal S1 is illustrated as a function of time in FIG. 6B. It alternately assumes a value of, for example, 0 V and 2.5 V, these numerical values as well (in the same way as the numerical values mentioned with reference to FIGS. 6A, 6C and 6D) only being by way of example. The additional switching element 13 is switched to a conducting state in each case when the control signal S1 assumes the value of 0 V, such as for example firstly in the time interval from 0 to 25 microseconds and afterwards for instance in the time interval from approximately 20 to 95 microseconds. In these time intervals, the output voltage V′ is pumped up via the further first switching element 11b. In order to avoid leakage currents, the substrate region of the additional switching element 13 is short-circuited with the input-side source/drain terminal, which is biased with the second electrical potential V1 via the input-side lead 5. The switching elements 11a, 11b and 13 are always switched to a conducting state simultaneously.

At least when the switching elements 11a, 11b and 13 are switched to a conducting state, the second switching elements 12 must be switched to a non-conducting state. Conversely, at least when the second switching elements 12 are switched to a conducting state, the switching elements 11a, 11b and 13 must be switched to a non-conducting state. This is achieved by the driving of the second switching elements 12 illustrated in FIG. 6 by the further control signals S2 and S2N, with which the gate electrodes of the second switching elements 12 are supplied. The control signal S1 is illustrated in FIG. 6D; the inverted control signal S2N results from the signal S2 by inverting the digital values 0 and 1. Whenever the control signal S2 assumes its maximum value (of 5 V, for example), the value of the inverted control signal S2N is 0 V. Conversely, the inverted control signal S2N assumes the maximum value whenever the control signal S2 is 0 V. By means of the control signal S2, the p-channel field effect transistors 12 connected to the connection lines 4b are switched to a conducting state in each case when the control signal S2 is 0 V. This is the case in accordance with FIG. 6D, for example, in the time interval from 0 to approximately 25 microseconds, and again thereafter in the time interval from approximately 95 to 120 microseconds. Although the voltage pump according to the invention requires only two different cycle times per pump cycle in order to pump the output voltage by a certain voltage magnitude in each case, in accordance with FIG. 6D it is preferably provided that the control signal S2 switches on the second switching elements 12 in each case only for a short time (for in each case approximately 25 milliseconds) and switches them off in each case for a comparatively long time (for example, for, in each case, 70 microseconds). This prevents a situation where, within the series circuit R, one of the first switching elements is momentarily jointly switched to a conducting state simultaneously with one of the second switching elements. Voltage spikes on account of short-circuit currents are thereby prevented.

The second switching elements 12 connected to the remaining connection lines 4a are n-channel field effect transistors. The gate electrodes thereof are, therefore, supplied with the inverted control signal S2N. The second switching elements 12 connected to the connection lines 4a in each case bias a capacitor electrode with the first electrical potential V0 in the switched-on state. At the same time, the second switching elements 12 connected to the connection lines 4b in each case bias a capacitor electrode with the second electrical potential V1. In order to avoid leakage currents, the substrate regions of the p-channel field effect transistors supplied with the control signal S2 are biased with the large positive, temporally constant control signal S5. In the case of the transistors 12 connected to the leads 4a, by contrast, the substrate region is short-circuited with the respective source-drain terminal on the input side via, which the first electrical potential V0 is provided. As a result, undesirable leakage currents are avoided in the case of the second switching elements 12, too.

In the case of the exemplary embodiment of the voltage pump 10 according to the invention as illustrated in FIG. 6, capacitors C1, C2 of a series circuit R are repeatedly short-circuited with one another, capacitor electrodes of two capacitors that are charged oppositely to one another in each case being short-circuited with one another via the connecting line 3. Such short-circuiting of capacitor electrodes that are charged oppositely to one another is not customary in a conventional voltage pump. Consequently, embodiments of the invention provide a new type of voltage pumps that can be operated with significantly less extensive driving and manages in particular with a small number of temporally variable control signals. These are essentially the control signals S2 and S4, in which case the respectively inverted control signals S2N and S4N can in each case be generated from the control signals with the aid of a corresponding inverter and, moreover, are necessary only when some of the switching elements are intended to be formed as p-channel transistors instead of as n-channel transistors (or vice versa). With regard to interchanging these two types of transistors and with regard to interchanging the voltage values and electrical potentials with those having an opposite sign, embodiments of the present invention can, in each case, be applied to both alternatives. Moreover, instead of the additional control signal S1, it is possible as an alternative to use the inverted control signal S2N, which is greater than the control signal S1 only by a constant factor.

The control signal S5 is temporally constant. Consequently, only the two control signals S2 and S4 remain as mutually independent, temporally variable control signals. The fact that these two control signals are used instead of a single control signal serves only for preventing a simultaneous opening of first and second switching elements in the transition from one cycle time to the next cycle time. In the limiting case where the first switching elements are switched to a conducting state whenever the second switching elements are switched to a non-conducting state, and vice versa, the control signals S2 and S4 are identical and have clock edges that occur temporally synchronously with one another. Two different S2, S4 are used merely in order to avoid this limiting case, the control signal S2 in accordance with FIG. 6D assuming a high potential for the majority of the time.

A conventional voltage pump scarcely manages with such a small number of control signals. Consequently, not only does the fact that the voltage pump according to the invention can be realized with trench capacitors lead to a considerable reduction of the required substrate area, but in addition there is a possibility of reducing the outlay and the space requirement for the electrical driving which provides the respectively required control signals by comparison with conventional voltage pumps.

What is claimed is:

1. An integrated semiconductor circuit comprising a voltage pump, the voltage pump comprising:
a series circuit of capacitors, each capacitor having a first capacitor electrode and a second capacitor electrode;
first switching elements, each switching element coupled between two of the capacitors of the series circuit, the switching elements effecting an electrical isolation of the capacitors from one another if they are switched to a non-conducting state;
connecting lines, wherein the first switching elements are coupled to the capacitor electrodes of the capacitors by the connecting lines;
connection lines coupled to a respective connecting line between a first switching element and a capacitor electrode; and
second switching elements, each second switching element effecting an interruption of the respective connection line if it is switched to a non-conducting state;
wherein the second switching elements can be jointly switched to a conducting state when all the first switching elements are switched to a non-conducting state to cause each capacitor to be electrically charged individually by two connection lines, and
wherein the first switching elements can be jointly switched to a conducting state when all the second switching elements are switched to a non-conducting state to cause all the electrically charged capacitors to be electrically coupled to one another.

2. The semiconductor circuit as claimed in claim 1, wherein the second capacitor electrode of each capacitor is coupled to the first capacitor electrode of a next capacitor of the series circuit of capacitors if the first switching elements are switched to a conducting state,
wherein those connection lines that are coupled to the first capacitor electrode via a respective connecting line can be jointly biased with a first electrical potential, and
wherein those connection lines that are coupled to the second capacitor electrode via a respective connecting line can be jointly biased with a second electrical potential, the second electrical potential being different from the first electrical potential.

3. The semiconductor circuit as claimed in claim 2, wherein when the first switching elements are switched to a non-conducting state, the second switching elements can be switched to a conducting state simultaneously relative to one another, as a result of which a voltage corresponding to the potential difference between the second electrical potential and the first electrical potential is present individually in each case at each capacitor of the series circuit.

4. The semiconductor circuit as claimed in claim 2, wherein the first switching elements of the series circuit are controlled in such a way that they are switched to a non-conducting state as long as the second switching elements are switched to a conducting state and the connection lines are biased with the first electrical potential and the second electrical potential.

5. The semiconductor circuit as claimed in claim 1, wherein when the second switching elements are switched to a non-conducting state, the first switching elements can be switched to a conducting state simultaneously relative to one another, as a result of which the capacitors are in each case conductively connected to one another.

6. The semiconductor circuit as claimed in claim 1, wherein the second switching elements of the connection lines are controlled in such a way that they are switched to a non-conducting state as long as the first switching elements are switched to a conducting state.

7. The semiconductor circuit as claimed in claim 1, wherein the first capacitor electrode of the first capacitor and the second capacitor electrode of a last capacitor of the series circuit are arranged at opposite ends of the series circuit of capacitors, and wherein a respective lead is coupled to the first capacitor electrode of the first capacitor and to the second capacitor electrode of the last capacitor, as a result of which an output voltage prevailing between the first capacitor electrode of the first capacitor and the second capacitor electrode of the last capacitor can be tapped off by means of two leads.

8. The semiconductor circuit as claimed in claim 7, wherein the lead coupled to the first capacitor electrode of the first capacitor is connected up in such a way that it can optionally be biased with the first electrical potential or with the second electrical potential.

9. The semiconductor circuit as claimed in claim 7 further comprising an additional switching element arranged within the lead coupled to the first capacitor electrode of the first capacitor.

10. The semiconductor circuit as claimed in claim 9, wherein the additional switching element can be switched to a conducting state jointly with all the first switching elements and can be switched to a non-conducting state jointly with all the first switching elements.

11. The semiconductor circuit as claimed in claim 1, wherein the series circuit is driven in such a way that all the first switching elements and all the second switching elements are jointly switched to a conducting state alternately relative to one another.

12. The semiconductor circuit as claimed in claim 9, wherein the series circuit is driven in such a way that the additional switching element is in each case switched to a conducting state simultaneously with the first switching elements.

13. The semiconductor circuit as claimed in claim 1, wherein each capacitor of the series circuit comprises an integrated trench capacitor.

14. The semiconductor circuit as claimed in claim 1, wherein the first switching elements and the second switching elements comprise integrated transistors.

15. The semiconductor circuit as claimed in claim 14, wherein the first switching elements and the second switching elements comprise field effect transistors.

16. The semiconductor circuit as claimed in claim 1, wherein all the capacitors of the series circuit are dimensioned in such a way that they each have a capacitance of identical magnitude.

17. The semiconductor circuit as claimed in claim 1, wherein the semiconductor circuit has a first series circuit and a second series circuit of capacitors with first switching elements that are coupled to the capacitors by connecting lines, and with second connection lines, which have second switching elements and are connected to the connecting lines,
a last capacitor of the first series circuit and a last capacitor of the second series circuit each being coupled to an output line for forwarding an increased output voltage.

18. The semiconductor circuit as claimed in claim 17, wherein the two series circuits of capacitors are driven in such a way that the first switching elements of the first series circuit are switched to a conducting state simultaneously with the second switching elements of the second series circuit and that the first switching elements of the second series circuit are switched to a conducting state simultaneously with the second switching elements of the first series circuit.

19. The semiconductor circuit as claimed in claim 17 further comprising a switching unit that cyclically couples in either the last capacitor of the first series circuit or the last capacitor of the second series circuit to the output line, the switching unit coupling the last capacitor of that series circuit to the output line whose electrical potential has the respectively greater potential difference with respect to the first potential.

20. A method for operating a semiconductor circuit, the method comprising:
providing a voltage pump having at least one series circuit of capacitors, a first switching element interposed between each of two adjacent ones of the capacitors, and connection lines that are coupled to connecting lines that couple each first switching element and a capacitor electrode of a capacitor to one another and in each case have a second switching element that effects an interruption of the respective connection line in the switched-off state; and
operating the semiconductor circuit such that the capacitors of the at least one series circuit of capacitors are short-circuited with one another in periodic time intervals and, between the periodic time intervals, are simultaneously charged individually with a voltage.

21. The method as claimed in claim 20, wherein for the purpose of short-circuiting the capacitors of the at least one series circuit with one another, all the first switching elements of the at least one series circuit are switched to a conducting state, while all the second switching elements of the at least one series circuit are switched to a non-conducting state.

22. The method as claimed in claim 20, wherein for the purpose of simultaneously charging all the individual capacitors of the at least one series circuit, all the second switching elements are switched to a conducting state, while all the first switching elements are switched to a non-conducting state.

23. The method as claimed in claim 20, wherein the capacitors of the voltage pump each include a first capacitor electrode and a second capacitor electrode, the second capacitor electrode of each capacitor being coupled to the first capacitor electrode of a next capacitor if the first switching elements are switched to a conducting state, and wherein, for the purpose of simultaneously charging all the individual capacitors of the at least one series circuit, all the first capacitor electrodes are biased with a first electrical potential and all the second capacitor electrodes are biased with a second electrical potential that is different from the first electrical potential.

24. The method as claimed in claim 23, wherein the first capacitor electrodes and the second capacitor electrodes of the capacitors are in each case biased with the aid of the connection lines.

25. The method as claimed in claim 20, wherein an output voltage generated by the at least one series circuit of capacitors is tapped off via two leads coupled to the first capacitor electrode of a first capacitor and to the second capacitor electrode of a last capacitor of the at least one series circuit.

26. The method as claimed in claim 20, wherein, when all the capacitors of the at least one series circuit are short-circuited with one another, an additional switching element, which couples the first capacitor electrode of the first capacitor of the at least one series circuit to the lead coupled thereto, is switched to a conducting state simultaneously with the first switching elements of the at least one series circuit, while the lead is biased with the second electrical potential.

27. The method as claimed in claim 20, wherein the at least one series circuit of capacitors includes a first series circuit and a second series circuit that are coupled to a switching unit, first switching elements of the second series circuit always being switched to a conducting state simultaneously with the second switching elements of the first series circuit and the second switching elements of the second series circuit always being switched to a conducting state simultaneously with the first switching elements of the first series circuit.

28. The method as claimed in claim 27, wherein the switching unit is controlled in such a way that it biases an output line coupled to the switching unit alternately with a potential of the second capacitor electrode of the last capacitor of the first series circuit and with a potential of the second capacitor electrode of the last capacitor of the second series circuit.

29. The method as claimed in claim 27, wherein the switching unit biases the output line in each case with a potential of the second electrode of the last capacitor of that series circuit which has a greatest potential difference with respect to a first electrical potential.

30. The method as claimed in claim 27, wherein the switching unit biases an output line with a potential which has, with respect to a first electrical potential, a potential difference corresponding to an integer multiple of the potential difference between the first electrical potential and a second electrical potential.
